(19) United States
(12) Patent Application Publication
(10) Pub. No.: US 2026/0330135 A1
(43) Pub. Date: Oct. 22, 2026

(54) CONTENT RENDERING VALIDATION

(71) Applicant: Wells Fargo Bank, N.A., San Francisco, CA (US)

(72) Inventors: Sandhya Adabala, Hyderabad (IN); Rameschandra Bhaskar Ketharaju, Hyderabad (IN); Aryan Kharbanda, New Delhi (IN); Sathish Parameshwara, Bengaluru (IN); Bhanu Sankaran, Concord, CA (US); Amol Sapatnekar, San Ramon, CA (US); Harsh Thakur, New Delhi (IN)

(21) Appl. No.: 19/181,848

(22) Filed: Apr. 17, 2025

(51) Int. Cl. G06F 40/226; G06Q 10/0631; G06Q 30/018; G06V 30/10

(52) U.S. Cl. CPC G06F 40/226; G06Q 10/06316; G06Q 30/018; G06V 30/10

(57) ABSTRACT

Validation of content for content rendering. The content can relate to legal and/regulatory notices and disclosures that must be provided to, and accepted by users, before certain workflows can be completed, such as applications for financial or healthcare services. Validation of content can occur at the backend prior to rendering the content on the user's computing device. Separately, or in addition, validation can occur with respect to content that has already been rendered on the user's computing device. If either type of validation fails, the user's workflow is paused until corrected content is generated and provided to the user's computing device.

### BACKGROUND

In heavily regulated industries like banking, finance and healthcare, legal and/or regulatory notices are required to be provided to customers seeking various products and/or services. The customers must review such notices and accept the terms of such notices before they can proceed with their requests. Customers may request certain products or services by initiating workflows on their computing devices, e.g., by using a website or software application associated with an enterprise in a heavily regulated industry, such as a financial institution or a healthcare institution. During the workflows, the required legal and/or regulatory notices are rendered on the customers'computing devices. The customers must interact with their computing devices in a way that indicates that they have understood and accepted the terms set forth in the legal and/or regulatory notices.

### SUMMARY

Examples provided herein are directed to validation and modification of content during workflow interactions with regulated enterprises.

According to one aspect, the present disclosure relates to a method performed by a server computing device for content validation during a workflow, including: receiving, from a client computing device, a request to perform a task; generating, in response to the request, an expected version of content; receiving, from a content provider computing device, an actual version of the content; and validating the actual version of the content, including: comparing the actual version of the content and the expected version of the content to generate a comparison score; when the comparison score is unacceptable based on a predefined threshold score, preventing the actual version of the content from rendering on a display device of the client computing device; and when the comparison score is acceptable based on the predefined threshold score, allowing the actual version of the content to be rendered on the display device of the client computing device.

According to another aspect, the present disclosure relates to a method performed by a server computing device for content validation during a workflow, including: receiving, from a client computing device, a request to perform a task; generating, in response to the request, an expected version of content; capturing an image of a rendering of content on a display device of the client computing device; extracting rendered content from the image; and validating the rendered content, including; comparing the rendered content and the expected version of the content to generate a comparison score; when the comparison score is unacceptable based on a predefined threshold score, preventing the workflow from proceeding on the client computing device until the rendered content is corrected on the display device of the client computing device; and when the comparison score is acceptable based on the predefined threshold score, allowing the workflow to proceed on the client computing device.

According to another aspect, the present disclosure relates to a system f or performing workflow content validation, including: a server computing device; a client computing device; content provider computing devices; processors; and non-transitory computer-readable storage media encoding instructions which, when executed by one or more of the processors, cause the system to: tokenize, by the server computing device, content provided by the content provider computing devices to provide tokenized content; generate, by the server computing device, content templates corresponding to content types, the content templates being based on the tokenized content; classify, using a machine learning classification model, each of the content templates with a classification based on factors associated with the content types, the factors including customer impact, regulatory impact, revenue impact, and reputational impact; send, by the client computing device, a request to perform a task; generate, by the server computing device in response to the request, an expected version of content, the expected version of the content being based on a selected one of the content templates modified based on data provided in the request; send, by one of the content provider computing devices, an actual version of the content; and validate, by the server computing device, the actual version of the content, including: compare the actual version of the content and the expected version of the content to generate a comparison score; compare the comparison score to a predefined threshold score, the predefined threshold score being calculated based on the classification; and when the comparison score is unacceptable based on the predefined threshold score, prevent the workflow from proceeding on the client computing device until the actual version of the content is modified by the server computing device and provided to the client computing device by the server computing device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows an example system for content rendering validation.

FIG. 2 schematically shows an example graphical interface that can be generated by the system of FIG. 1 during a workflow.

FIG. 3 schematically shows an example method that can be performed using the system of FIG. 1.

FIG. 4 schematically shows another example method that can be performed using the system of FIG. 1.

FIG. 5 shows example physical components of one or more devices of the system of FIG. 1.

### DETAILED DESCRIPTION

This disclosure relates to content validation during customer workflows.

Legal and regulatory compliance is crucial to many enterprises, such as enterprises operating in financial industries and/or healthcare industries. Different products and services (e.g., applying for a loan, or requesting a particular medical procedure) requested by a customer from such enterprises can trigger different legal and/or regulatory content that the customer must review and consent to before the product or service can be provided. The actual legal and/or regulatory content can be provided by various different sources, such as different regulatory groups, compliance groups and/or government organizations. In addition, as laws and regulations change, the requirements governing the nature and scope of legal and/or regulatory content and how such content is presented to a customer can also change, creating challenges for enterprises trying to ensure up-to-date compliance with laws and regulations.

A related challenge is that legal and regulatory content is more commonly available in various different formats, such as text, portable document format (PDF), hypertext markup language (HTML), tabular format, and images, that require different extraction and validation approaches one from another for proper rendering on the customer's computing device.

Another related challenge is that the scope of the content that must be reviewed and approved by a given customer for a given workflow can be dynamic and conditional upon, for example, the type of product or service being requested, the account type (e.g., an investment account, a home mortgage account, a banking account), the geographical region where the customer is located, and other transaction details, complicating the process of validating the legal and/or regulatory content that is provided.

Another related challenge is ensuring the content has not been tampered with or modified in transit as it is transmitted from one computing device to another, such as from a third party compliance or government organization device to a customer device.

Another related challenge is handling of a network glitch or content provider computing device glitch that results in failure of the required content to arrive at, and/or be properly rendered by, the customer's computing device. Such glitches can occur anywhere within the expansive network of numerous computing devices and network hardware involved in handling a request that triggers requirement of consent to legal and/or regulatory content. Detecting or otherwise identifying when such a glitch has prevented the proper content from being rendered to the customer can be critical.

Another related change is ensuring clarity, readability and effectiveness of the content in how it is visually presented, such as ensuring compliance with font type and size requirements.

Another related challenge is ensuring that the content that is pushed to the customer's device actually renders properly on the customer's device.

An enterprise that fails to adequately overcome these and other challenges in obtaining consent from a customer to the properly and appropriately rendered content for that customer's specific circumstances can face severe consequences, such as legal and regulatory penalties, reputational damage, financial losses, and customer mistrust.

The present disclosure can alleviate one or more of the foregoing challenges by providing validation of legal and regulatory content in real time (e.g., while the workflow request is pending), and without delays that could impact compliance.

The present disclosure provides advantages in validation of content that reflect improvements in technology. For example, validating content during an initiated customer workflow can include generating expected content, comparing the actual version of the content and the expected version of the content to generate a comparison score and, when the comparison score is unacceptable, preventing the actual version of the content from rendering on a display device of the client computing device.

As another example of an improvement in technology, an image of a rendering of content on a display device of a client computing device during an initiated customer workflow is captured; rendered content from the image is extracted and validated by comparing the rendered content and expected content and, when the comparison score is unacceptable, the workflow is prevented from proceeding on the client computing device until the rendered content is corrected on the display device of the client computing device.

As another example of an improvement in technology, when content is detected to be unacceptable during an initiated customer workflow the workflow is prevented from proceeding on the client computing device until the content is modified and the modified version is provided to the client computing device.

As another example of an improvement in technology, content that fails one or more validation benchmarks can be autonomously corrected based on a corresponding pre-stored content template.

Other improvements in technology will be borne out by the present disclosure.

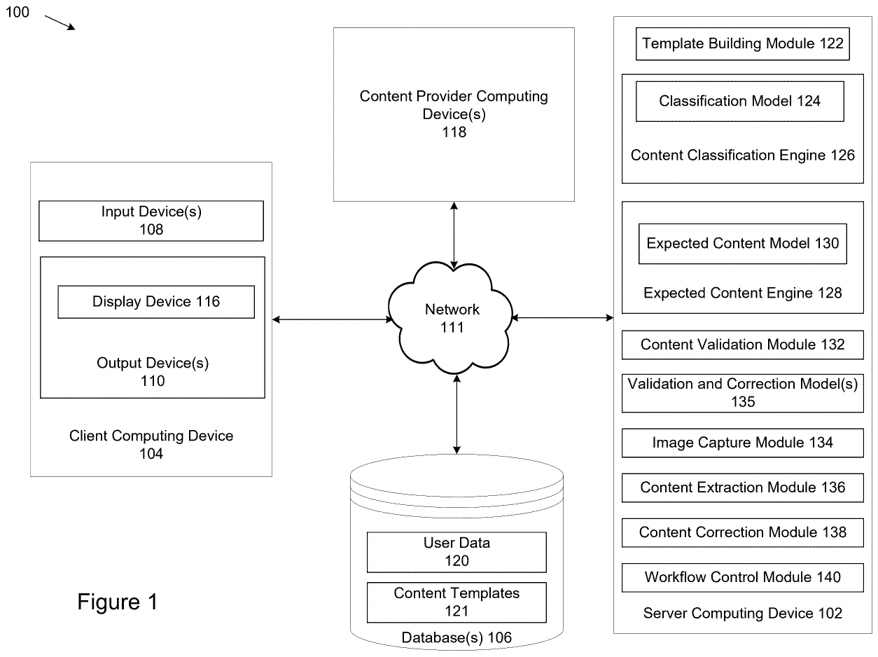

FIG. 1 schematically shows an example system 100 for content rendering validation.

The system 100 includes a server computing device 102 (also referred to as a server), a client computing device 104 (also referred to as a client device), one or more content provider computing devices 118 (also referred to as provider device(s)), and one or more databases 106 that are operatively linked to one another over a data network 111.

Each provider device 118 is associated with a provider of legal and/or regulatory content, such as a regulations organization or a government agency that promulgates rules and creates legal and/or regulatory content (e.g., notices) that must be consented to by customers in order for the customers to receive certain products or services, such as healthcare services or financial services. One example of such a regulatory notice concerns the risk that the customer's private data may be used by other parties in certain ways. Another example of a such a regulatory notice concerns the possibility of financial loss by proceeding with a particular investment or loan. Many different types of legal and/or regulatory content exist for many different types of regulated products and services.

The client device 104 includes input device(s) 108. The input device(s) 108 can include, for example, a microphone, a touch screen (on the display device(s) 116), a keyboard, a mouse, a video camera, and the like. The client device 104 can be, for example, a customer's personal device, such as a smartphone, a tablet, a desktop computer or a laptop computer. The client device 104 can alternatively be a user terminal located at physical location of an enterprise from which the customer is seeking services, such as in a doctor's office or a brick and mortar branch of a financial institution.

The client device 104 includes output device(s) 110, which include the display device(s) 116. Other output devices 114 can include, for example, a speaker. The display device(s) 116 is/are configured to display graphical interfaces such as graphical interfaces that display legal and/or regulatory content and interactive prompts by which the customer can consent to the content that is presented to them. The display device(s) 116 can be configured to receive touch inputs, typed inputs, mouse inputs and the like.

The server 102 includes a template building module 122, a content classification engine 126, an expected content engine 128, a content validation module 132, an image capture module 134, a content extraction module 136, a content correction module 138, one or more validation and correction model(s) 135, and a workflow control module 140.

The content classification engine 126 can include one or more classification models 124. The classification model 124 can be a machine learning model.

The expected content engine 128 can include one or more expected content model 130. The expected content model 130 can be a machine learning model.

Other components of the server 102 and the system 100 can use one or more machine learning models to perform their functionality.

Over the network 111, the server 102 receives legal and/or regulatory content from the provider device(s) 118. The template building module 122 generates a plurality of templates based on this content. There can be a different template for each identified type of content.

The content can come in different formats such as text, PDFs, HTML, or images that are ingested by the server 102. The template building module 122 can be configured to determine the format of a given piece of content and employ the appropriate software to extract the content. For example, the template building module 122 can employ optical character recognition (OPR) to extract text from image-based content. The template building module can employ other extraction tools to parse PDFs and extract relevant data, and still other extraction tools to extract text from HTML formatted content.

The content is thus processed by the template building module 122 and converted to machine-readable text. For instance, the raw content ingested by the server 102 may include images and tables that the template building module 122 automatically converts to machine readable text.

Once the content has been converted to machine readable text, the template building module 122 is configured to normalize and tokenize the now machine-readable text, and use the tokenized text to build content templates for the different types of content that have been ingested. The template building module 122 can include a customized tokenizer that recognizes and can tokenize terms and abbreviations that are specific to the legal and/or regulatory frameworks underlying the different types of content.

The server 102 can save the content templates 121 to the database(s) 106.

The content classification engine 126 is configured to classify each content template 121. The content classification engine uses the classification model 124 to score the content corresponding to each content template 121 against different predefined categories, such as a customer category, a regulatory category, a revenue category and a reputational impact category. Many other categories are possible. A given piece of content and corresponding template can fall within multiple categories to different degrees as assessed by the classification model 124.

In this example, the customer impact category refers to content that affect customers, such as data breaches, service interruptions or privacy issues. The regulatory category refers to content for compliance with the laws and that carry fines if violated. The revenue category refers to content that affects financial performance such as loss of key customer, and operational disruptions impacting income. The reputational impact category refers to content that affects an enterprise's image such as ethical violations, negative press, and public controversies.

In examples, the classification model 124 builds on a transformer-based architecture. The architecture is then customized by adding a multi-label classification head with a sigmoid activation layer to predict probabilities for each category independently.

In examples, the training process for the classification model 124 uses a binary cross-entropy loss function, optimized with dynamic class weighting to address imbalanced category distributions, thereby enabling the classification model 124 to effectively capture the overlap between categories for a given piece of content and corresponding content template 121.

Classifications of the content templates 121 can also be stored in the database(s) 106, e.g., as metadata associated with the respective content templates 121.

A customer, via the input device(s) 108 and output device(s) 110 of the client device 104, initiates a workflow with a request to receive a particular product or service, such as a particular medical treatment or an application for a loan.

The request is received via the network 111 by the server 102 and processed. The server 102 recognizes that the request triggers a requirement for review and consent by the customer of legal and/or regulatory content in order for the customer to be permitted to continue with the workflow and finalize the request for the regulated product or service. For instance, the customer clicks a button on the display device 116 indicating to “display legal/regulatory content”. Clicking of the button causes the server 102 to request the actual content from the appropriate provider device 118.

The server 102 then requests the relevant content from the appropriate provider device 118. In parallel, the expected content engine 128 springs to action and generates expected (or predicted) content based on the request.

The expected content engine 128 first pulls a content template 121 from the database 106 that corresponds to the type of request of the initiated workflow. The expected content engine 128 then modifies the selected template based on embedded data within and/or associated with the request. For instance, such embedded data can include a value of the request, a date and time of the request, a geographical region from which the request was made, the type of account from which the request is made, and the like. Additional embedded data that informs and updates the content template can be sourced from the user data 120 stored on the database 106 and corresponding to the customer making the request. For example, the user data 120 can include user profile data about the customer's relationship with enterprise, and other personal information that are relevant to the scope of the legal and/or regulatory content that must be provided to the customer during the given workflow.

The expected content model 130 is trained to update the content templates 121 based on data embedded in the customer request that is relevant to the scope of content to be provided, as well as other customer-specific data such as profile data from the user data 120 that pertains specifically to the customer making the request.

The server 102 now has two versions of the content associated with the workflow request: (1) the actual content obtained from the provider device 118 and (2) the expected content generated by the expected content engine 128.

The content validation module 132 is configured to compare the actual content and the expected content in real time (e.g., while the workflow request is pending) to determine, and evaluate the significance of, any discrepancies between the two versions of the content.

The content validation module 132 is configured to perform various validation techniques to compare and check for discrepancies. Any determined discrepancies are scored by the content validation module 132 and, based on the score, the actual content is either approved or not approved by content validation module. That is, if the actual content is approved it passes validation, and if the actual content is not approved, it fails validation. Actual content that fails validation is then provisioned for automatic correction, as described below.

Examples of content validation techniques that can be performed by the content validation module 132 will now be described.

The content validation module 132 can employ hash validation using cryptographic hash function that is triggered to ensure content integrity by comparing the hash values of the expected content and the actual content. If the actual content passes this stage of validation, it means the actual content is character-by-character accurate, and no further validation checks are needed.

However, if the hash validation fails, it indicates that there might be missing punctuation, words, or phrases. In such cases, the content module 132 can next employ a string matching algorithm to measure the number of edits (e.g., insertions, deletions, or substitutions) needed to convert one string into another. A predefined threshold score is set. If the string matching score exceeds the threshold, it indicates significant differences in punctuation or words.

Following hash validation and string matching, natural language processing validation is performed by the content validation module 132 using a custom transformer-based model. Such a model ensures that the content matches semantically, even if it is presented or phrased differently.

The content validation module 132 compares the expected content with the actual content based on an aggregated set of data outputs from the different validation techniques being employed. The content validation module 132 then scores the level of discrepancy and compares the score to a predefined classification threshold score. This predefined threshold score is determined based on the classification of the corresponding template that was modified to generate the expected content. For example, content accuracy is more critical when the underlying template, as modified with embedded request data, has a classification indicating a high level of criticality that the content is accurately rendered than when the underlying modified template has a classification indicating a low level of criticality that the content is accurately rendered.

If the actual content passes validation based on the comparison of the discrepancy score to the predefined threshold for the corresponding template, the actual content is displayed to the customer on the display device 116 in real time. If the actual content fails validation based on the comparison of the discrepancy score to the predefined threshold for the corresponding template, then the workflow control module 140 springs into action, causing the server 102 to generate signals that cause the client device 104 to prevent the pending workflow from proceeding until the actual content is sufficiently corrected to pass validation and can be rendered on the display device 116.

When the content validation module 132 determines a validation failure, the content correction module 138 springs into action. The content correction module 138 is configured to modify and update the actual content to be more aligned with the expected content.

The content correction module 138 allows for self-managing and self-healing of the actual content with minimal human intervention. The content correction module 138 and the content validation module 132 can include one or more machine learning models having algorithms inspired by the human nervous system, which autonomically responds to changes without conscious effort.

The content correction module 138 listens for validation failures generated by the content validation module 132.

Once the content correction module 138 receives a validation failure, the content correction module invokes a customized machine learning model (e.g., a validation and correction model 135) that auto-generates suggested fixes based on the mismatches between the actual content and the expected content.

In some examples, once the content fixes are available, the content correction module 138 causes the server 102 to generate a push notification to a human enterprise stakeholder for review and approval of the suggested fixes. The stakeholder can review, edit, and approve the suggested fixes and push the suggest fixes back to the server 102, which triggers the workflow control modules 140 to allow the workflow to proceed on the client device 104, with the fixed and approved actual content being pushed to the client device 104 and displayed on the display device 116 for the customer to review and indicate consent.

The validation and correction model(s) 135 used by the content correction module 138 and the content validation module 132 can be customized model(s) built on a generative pretrained transformer-based model enhanced with a retrieval-augmented generation (RAG) framework. The validation and correction model(s) 135 starts with a dual input encode layer that processes the actual content and expected content separately to identify mismatches. A retrieval layer is integrated to an external knowledge base (e.g., the provider device 118 and/or the databases(s) 106) containing the corresponding legal and/or regulatory documents and compliance policies for relevant information based on the identified mismatches. This information is passed to an anomaly detection layer of the validation and correction model(s) 135, which classifies issues such as grammatical errors, compliance violations, meaning ambiguities, and the like. The correction layer of the validation and correction model(s) 135 then uses the retrieved knowledge and the validation and correction model(s) 135 generation capabilities to rewrite the actual content, ensuring it complies with the expected content while following regulatory standards.

In some examples, the validation and correction model(s) 135 can also create an explanatory file for each correction, including the flagged issue, the correction made and related regulations. The explanatory file can be pushed to the stakeholder to review during the review and approval process for the corrected content, and saved to the database 106.

The use of a RAG framework ensures that the validation and correction model(s) 135 provides precise, up to date regulatory references, making auto-correction process highly accurate and reliable.

The server 102 is configured to continuously monitor validation results in the validation logs stored on the database(s) 106. If, in a given instance, a validation failure is not resolvable in real time (e.g., during the pending workflow), an offline correction process can be initiated. The offline process can trigger the validation and correction model(s) 135 to generate the suggested corrected content. The server 102 then generates an escalated paging request to one or more relevant stakeholders, facilitating immediate action.

Once the modified actual content is approved, the server 102 sends a message (e.g., an email) using Simple Mail Transfer Protocol to the customer or otherwise initiates a process to mail the physical documents to the customer with the modified actual disclosure content and asking for acknowledgement.

The validation and correction model(s) 135 receives validation results back as part of a learning feedback loop to enable automatic fine tuning of the validation and correction model(s) 135.

Once the actual content or modified actual content is determined to be acceptable (i.e., passes validation), it is pushed to the client device 104 for rendering on the display device 116. At this point, the image capture module 134 springs into action in real time (e.g., while the workflow is pending) and captures an image of the rendered content on the display device 116.

The content extraction module 136 then employs a data extraction technique, e.g., OCR, to extract text from the captured image.

The expected content engine 128, content validation module 132, validation and correction model(s) 135 and content correction module 138 then work on the extracted text from the captured image to determine any mismatches between the rendered content and the expected content, as previously described, except now the content being tested for accuracy is the rendered content, rather than the actual content prior to rendering. These modules then score the discrepancies and determine if the discrepancies require correction based on the scoring, as previously described. If corrections are needed, modifications to correct the rendered content are made automatically as previously described. Once the rendered content or corrected rendered content is approved, it is pushed from the server 102 to the client device 104 for rendering on the display device 116. In some examples, until the rendered content or modified rendered content passes validation, the workflow control module 140 prevents the workflow from proceeding, e.g., by graying out the interactive element on the interface displayed on the display device 116 that would allow the customer to consent to the rendered content.

Once the actual content or modified actual content is deemed to be properly rendered on the display device 116, the workflow control module 140 causes the server 102 to generate signals allowing the workflow to proceed on the client device 104. For example, the workflow control module 140 can cause the grayed out interactive element on the displayed interface to be active and selectable such that, upon its selection, the workflow proceeds to the next step.

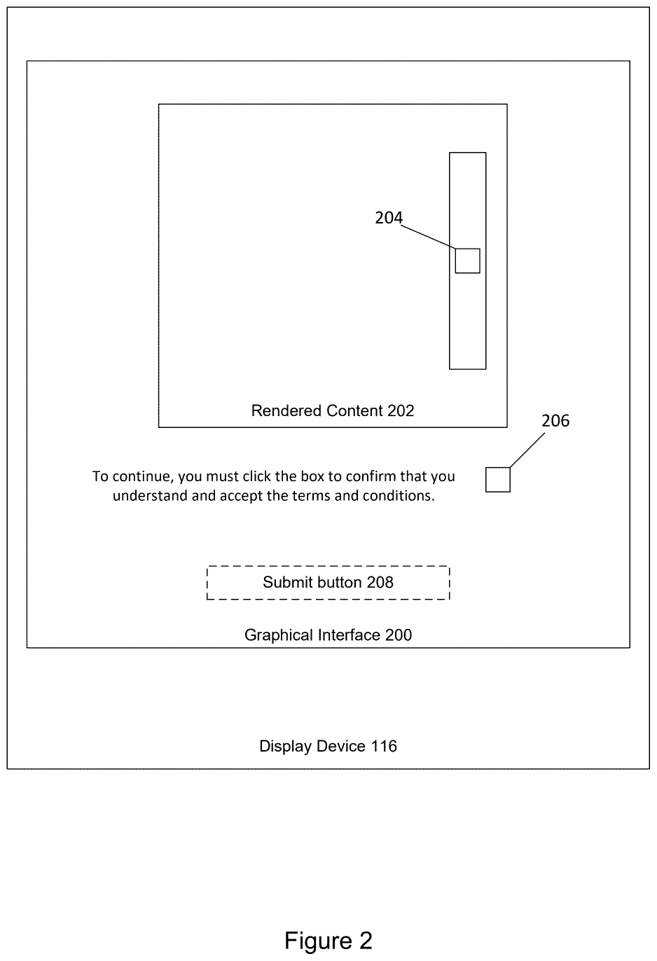

FIG. 2 schematically shows an example graphical interface 200 that can be generated by the system of FIG. 1 during a workflow.

The graphical interface 200 can be generated on the display device 116 and controlled by the workflow control module 140 (FIG. 1).

The graphical interface 200 includes rendered content 202 in text format, as well as a scrolling tool 204 for scrolling up and down through the rendered content 202.

The graphical interface 200 includes a box 206 that must be selected to indicate that the rendered content is consented to, before the submit button 208 becomes active. However, the box 206 can be controlled by the workflow control module 140 as described above (e.g., by graying out and/or making it active) to prevent the customer from being able to click the box 206, thereby preventing the submit button 208 from becoming active, which thereby prevents the pending workflow from proceeding.

Once the rendered content 202 is approved using the server 102 (FIG. 1), the workflow control module 140 (FIG. 1) re-enables the box 206, allowing the rendered content 202 to be consented to, which when it is consented to, enables the submit button 208, which can then be clicked to proceed with the workflow.

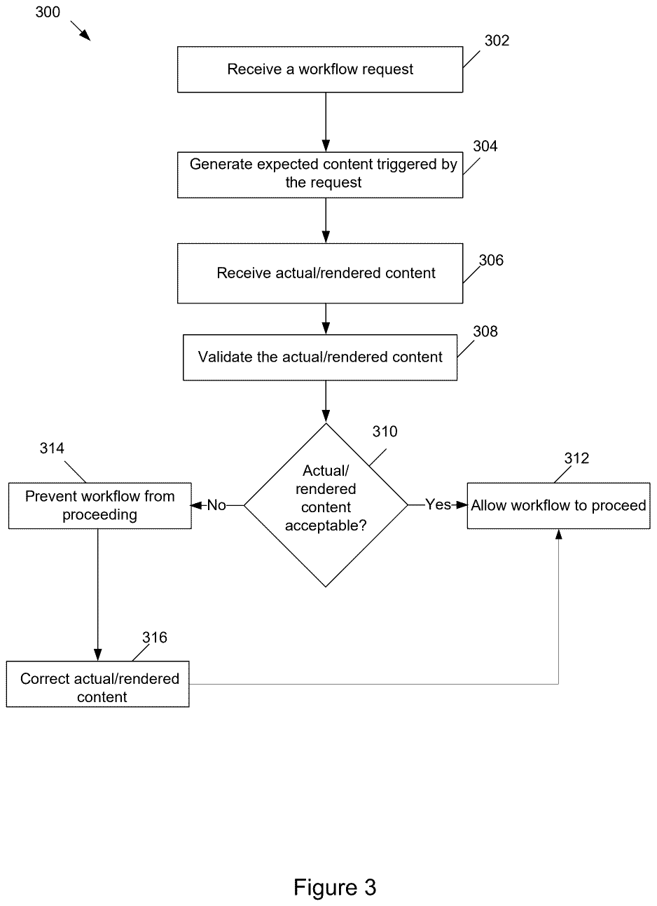

FIG. 3 schematically shows an example method 300 that can be performed using the system of FIG. 1. The method 300 may include more or fewer steps than the steps that are depicted. In addition, the depicted steps need not be performed in the depicted order, except where indicated. In some examples, some or all of the steps of the method 300 are performed by the server 102 (FIG. 1).

At a step 302 of the method 300, a workflow request is received.

At a step 304 of the method 300, expected content triggered by the request is generated.

At a step 306 of the method 300, actual content or rendered content is received. Actual content can be content received from a provider device 118 (FIG. 1). Rendered content can be content that has been captured from the display device 116 (FIG. 1).

At a step 308 of the method 300, the actual content or rendered content is validated.

At the step 310 of the method 300, it is determined if the actual content or rendered content is acceptable, that is, if the actual content or rendered content passes or fails validation.

If at the step 310 it is determined that the actual content or rendered content passes validation, the method 300 proceeds to the step 312, and the workflow is allowed to proceed.

If at the step 310 it is determined that the actual content or rendered content fails validation, the method 300 proceeds to the step 314, at which the workflow is prevented from proceeding.

From the step 314 the method 300 can proceed to the step 316 at which the actual content or rendered content is corrected.

Once the content is corrected and approved, the method can proceed to the step 312, allowing the workflow to proceed.

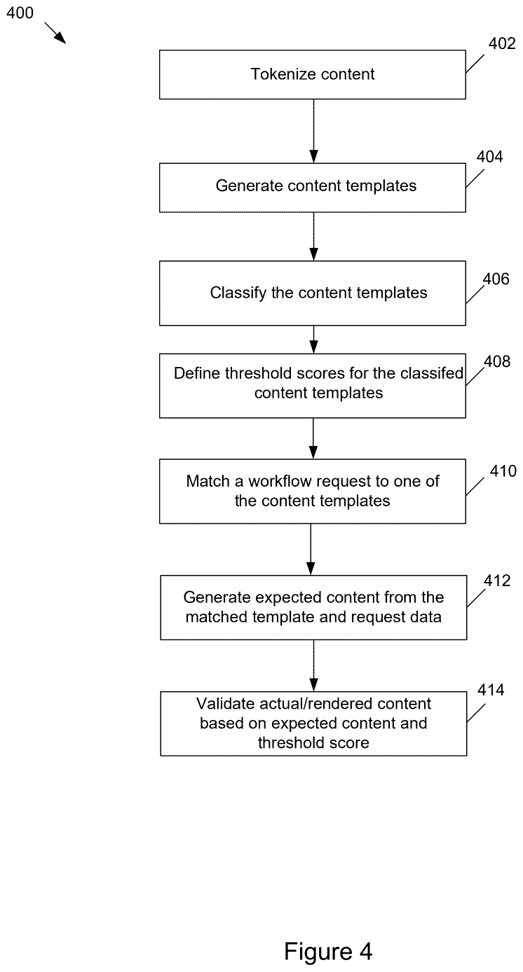

FIG. 4 schematically shows another example method 400 that can be performed using the system of FIG. 1. The method 400 may include more or fewer steps than the steps that are depicted. In addition, the depicted steps need not be performed in the depicted order, except where indicated. In some examples, some or all of the steps of the method 300 are performed by the server 102 (FIG. 1).

Aspects of the method 400 can be combined with one or more aspects of the method 300 (FIG. 3), and vice versa. For example, at least some aspects of the method 400 can be performed before commencing the method 300 (FIG. 3). For instance, the content templates generated in the method 400 can be used to generate the expected content in the method 300 (FIG. 3).

At a step 402 of the method 400, content (e.g., content received from a provider device 118 (FIG. 1) is tokenized.

At a step 404 of the method 400, content templates are generated using the tokenized content.

At a step 406 of the method 400, the content templates are classified according to various categories.

At a step 408 of the method 400, threshold scores are defined for each classified content template.

At a step 410 of the method 400, a pending workflow request is matched to one of the classified content templates.

At a step 412 of the method 400, expected content is generated from the matched templated and embedded data associated with the workflow request.

At a step 414 of the method 400, actual content or rendered content is validated based on the expected content generated and the threshold score of the corresponding content template. In some examples, the threshold score has been modified based on modifications made to the content template.

### Computing Architecture

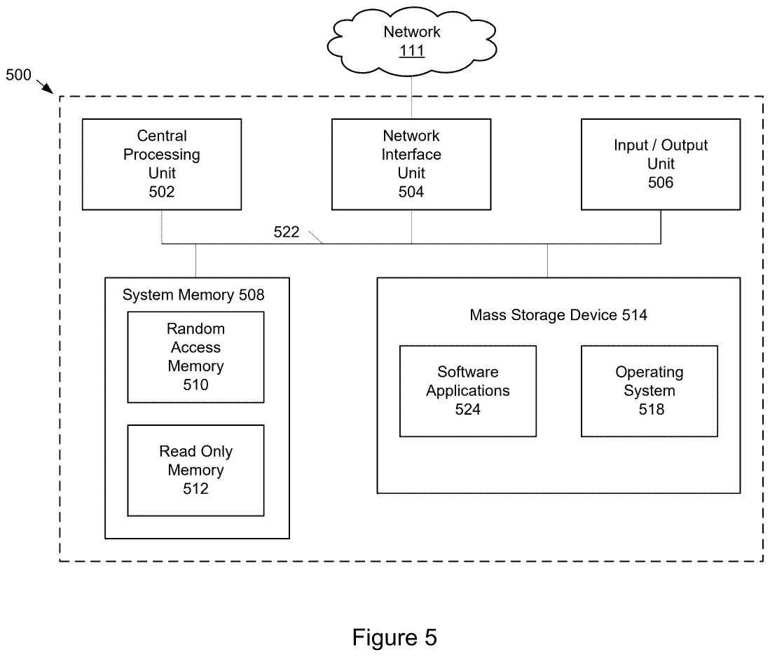

Additional components of the system 100 of FIG. 1 are illustrated in FIG. 5.

The electronic computing device 500 can correspond to any of the server computing device 102, the client computing device 104, and the content provider computing device(s) 118 of the system 100 of FIG. 1. Components of the computing device 500 can correspond to other components of the system 100 of FIG. 1, such as the database(s) 106.

When the computing device 500 corresponds to the server computing device 102, the computing device 500 can be an internally controlled and managed device (or multiple devices) of an enterprise. Alternatively, the computing device 500 can represent one or more devices operating in a shared computing system external to the enterprise, such as a cloud.

As illustrated in the embodiment of FIG. 5, the example computing device 500, which provides the functionality described herein, can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the computing device 500, such as during startup, is stored in the ROM 512. The computing device 500 further includes a mass storage device 514. The mass storage device 514 can store software instructions and data such as the various modules and engines depicted in FIG. 1. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the computing device 500. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 500.

According to various embodiments of the invention, the computing device 500 may operate in a networked environment using logical connections to remote network devices through network 111, such as a wireless network, the Internet, an NFC network, or another type of network, or combination of networks. The computing device 500 may connect to a network 111 through a network interface unit 504 connected to the system bus 522. It should be appreciated that the network interface unit 504 may also be utilized to connect to other types of networks and remote computing systems. The computing device 500 also includes an input/output controller 506 for receiving and processing input from a number of other devices, including a touch user interface display screen or another type of input device, such as a microphone a, keyboard, a mouse, and the like. Similarly, the input/output controller 506 may provide output to a touch user interface display screen or other output devices, such as a speaker, a haptic generator (e.g., a vibrating structure), or the like.

As mentioned briefly above, the mass storage device 514 and the RAM 510 of the computing device 500 can store software instructions and data. The software instructions include an operating system 518 suitable for controlling the operation of the computing devices of the system 100. The mass storage device 514 and/or the RAM 510 also store software instructions and applications 524, that when executed by the CPU 502, cause the computing device 500 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method performed by a server computing device for content validation during a workflow, comprising:
receiving, from a client computing device, a request to perform a task;
generating, in response to the request, an expected version of content;
receiving, from a content provider computing device, an actual version of the content; and
validating the actual version of the content, including:
comparing the actual version of the content and the expected version of the content to generate a comparison score;
when the comparison score is unacceptable based on a predefined threshold score, preventing the actual version of the content from rendering on a display device of the client computing device; and
when the comparison score is acceptable based on the predefined threshold score, allowing the actual version of the content to be rendered on the display device of the client computing device.

2. The method of claim 1, wherein the task includes an application for a financial service or a healthcare service.

3. The method of claim 1, wherein the expected version is generated based on:
selecting, based on the request, a content template of a plurality of content templates; and
modifying the content template based on data provided in the request to generate the expected version of the content.

4. The method of claim 1, wherein the comparison score is generated by:
performing a hash validation on the actual version of the content and the expected version of the content;
when the hash validation fails, performing a string matching algorithm on the actual version of the content and the expected version of the content; and
when the hash validation fails and a string matching score generated by (ii) is unacceptable, performing natural language processing validation on the actual version of the content and the expected version of the content.

5. The method of claim 1, further comprising:
generating content templates corresponding to content types; and
classifying, using a machine learning classification model, each of the content templates with a classification,
wherein the expected version of the content is a modified version of one of the content templates; and
wherein the predefined threshold score is based on the classification.

6. The method of claim 5, wherein the machine learning classification model classifies the content templates based on factors associated with the content types, the factors including customer impact, regulatory impact, revenue impact, and reputational impact.

7. The method of claim 6, further comprising refining the machine learning classification model based on the request.

8. The method of claim 6, wherein the classifying using the machine learning classification model is performed using a transformer-based architecture customized with a multi-label classification head and a sigmoid activation layer.

9. The method of claim 1, further comprising:
when the comparison score is acceptable:
capturing an image of a rendering of the actual version of the content on the display device of the client computing device;
extracting rendered content from the image; and
validating the rendered content.

10. The method of claim 9,
wherein validating the rendered content includes comparing the rendered content and the expected version of the content to determine if the rendered content is acceptable;
wherein when the rendered content is acceptable, allowing the workflow to proceed on the client computing device; and
wherein when the rendered content is unacceptable, preventing the workflow from proceeding on the client computing device until the rendered content is corrected on the display device of the client computing device.

11. The method of claim 10, wherein the extracting includes performing optical character recognition on the image.

12. The method of claim 10, further comprising:
when the rendered content is unacceptable, modifying the rendered content to provide modified rendered content; and
outputting the modified rendered content to the client computing device such that the rendered content is corrected on the display device of the client computing device.

13. The method of claim 12, wherein the modified rendered content is generated in a pop-up window on the display device of the client computing device.

14. The method of claim 1, further comprising:
when the comparison score is unacceptable based on the predefined threshold score,
modifying the actual version of the content to provide a modified version of the content; and
outputting the modified version of the content to the client computing device such that the modified version of the content is rendered on the display device of the client computing device.

15. A method performed by a server computing device for content validation during a workflow, comprising:
receiving, from a client computing device, a request to perform a task;
generating, in response to the request, an expected version of content;
capturing an image of a rendering of content on a display device of the client computing device;
extracting rendered content from the image; and
validating the rendered content, including;
comparing the rendered content and the expected version of the content to generate a comparison score;
when the comparison score is unacceptable based on a predefined threshold score, preventing the workflow from proceeding on the client computing device until the rendered content is corrected on the display device of the client computing device; and
when the comparison score is acceptable based on the predefined threshold score, allowing the workflow to proceed on the client computing device.

16. The method of claim 15, wherein the extracting includes performing optical character recognition on the image.

17. The method of claim 15, further comprising:
when the rendered content is unacceptable, modifying the rendered content to provide modified rendered content; and
outputting the modified rendered content to the client computing device such that the rendered content is corrected on the display device of the client computing device.

18. The method of claim 15, further comprising:
generating content templates corresponding to content types; and
classifying, using a machine learning classification model, each of the content templates with a classification,
wherein the expected version of the content is a modified version of one of the content templates;
wherein the predefined threshold score is based on the classification; and
wherein the comparison score is generated by:
performing a hash validation on the rendered content and the expected version of the content;
when the hash validation fails, performing a string matching algorithm on the rendered content and the expected version of the content; and
when the hash validation fails and a string matching score generated by (ii) is unacceptable, performing natural language processing validation on the rendered content and the expected version of the content.

19. A system for performing workflow content validation, comprising:
a server computing device;
a client computing device;
content provider computing devices;
processors; and
non-transitory computer-readable storage media encoding instructions which, when executed by one or more of the processors, causes the system to:
tokenize, by the server computing device, content provided by the content provider computing devices to provide tokenized content;
generate, by the server computing device, content templates corresponding to content types, the content templates being based on the tokenized content;
classify, using a machine learning classification model, each of the content templates with a classification based on factors associated with the content types, the factors including customer impact, regulatory impact, revenue impact, and reputational impact;
send, by the client computing device, a request to perform a task;
generate, by the server computing device in response to the request, an expected version of content, the expected version of the content being based on a selected one of the content templates modified based on data provided in the request;
send, by one of the content provider computing devices, an actual version of the content; and
validate, by the server computing device, the actual version of the content, including:
compare the actual version of the content and the expected version of the content to generate a comparison score;
compare the comparison score to a predefined threshold score, the predefined threshold score being calculated based on the classification; and
when the comparison score is unacceptable based on the predefined threshold score, prevent the workflow from proceeding on the client computing device until the actual version of the content is modified by the server computing device and provided to the client computing device by the server computing device.

20. The system of claim 19, comprising further instructions, when executed by one or more of the processors, which cause the server computing device to:
when the comparison score is unacceptable based on the predefined threshold score, prevent the client computing device from receiving the actual version of the content from the one of the content provider computing devices.
